(19) United States
(12) Patent Application Publication
(10) Pub. No.: US 2009/0163629 A1
(43) Pub. Date: Jun. 25, 2009

(54) FLAMEPROOFED IMPACT-MODIFIED POLYCARBONATE COMPOSITION

(75) Inventors: Thomas ECKEL, Dormagen (DE); Vera BUCHHOLZ, Koln (DE); Dieter WITTMANN, Leverkusen (DE); Eckhard WENZ, Koln (DE)

Correspondence Address: Baker Donelson Bearman, Caldwell & Berkowitz, PC, 555 Eleventh Street, NW, Sixth Floor, Washington, DC, 20004, US

(73) Assignee: BAYER MATERIALSCIENCE AG, Leverkusen (DE)

(21) Appl. No.: 12/338,416

(22) Filed: Dec. 18, 2008

(30) Foreign Application Priority Data
Dec. 20, 2007 (DE) 10 2007 061 758.7

(51) Int. Cl. C08K 5/5313; B29C 45/00; B29C 49/00; B29C 47/00

(52) U.S. Cl. 524/133; 264/328.1; 264/176.1; 264/500

(57) ABSTRACT

The present invention relates to impact-modified polycarbonate compositions comprising
A) 50 to 99.4 parts by wt. (in each case based on the sum of the parts by weight of components A+B+C) of aromatic polycarbonate and/or aromatic polyester carbonate,
B) 0.5 to 20 parts by wt. (in each case based on the sum of the parts by weight of components A+B+C) of graft polymer containing a silicone rubber or silicone/acrylate rubber,
C) 0.1 to 30 parts by wt. (in each case based on the sum of the parts by weight of components A+B+C) of a salt of a phosphinic acid.
   which are distinguished by an optimum combination of good flameproofing, high heat distortion temperature, good mechanical properties and good resistance to chemicals, the use of the polycarbonate compositions for the production of shaped articles and the shaped articles themselves.

### CROSS REFERENCE TO RELATED APPLICATION

This application claims priority from DE 102007061758 filed Dec. 20, 2007, the content of which is incorporated herein by reference in its entirety.

### BACKGROUND OF THE INVENTION

1. Field of the Invention

The present invention relates to an impact-modified polycarbonate composition which comprises a graft polymer containing a silicone or silicone/acrylate rubber and a salt of a phosphinic acid, the use of a polycarbonate composition for the production of shaped articles and the shaped articles themselves.

2. Description of Related Art

WO-A 2005/044906 discloses thermoplastic moulding compositions comprising at least one metal salt of hypophosphoric acid and at least one aromatic polycarbonate resin and a mixture thereof with a styrene-containing graft copolymer resin having a rubber content of 5-15%. The contents of the styrene-containing graft copolymer are 10-40 wt. %. The moulding compositions obtained are distinguished by good flame resistance, high heat stability under processing conditions and good weather resistance. Because of the low rubber content, other properties, in particular mechanical properties, are at a low level.

WO-A 1999/57192 describes thermoplastic moulding compositions comprising 5-96 wt. % of a polyester or polycarbonate, 1-30 wt. % of a phosphinic acid salt and/or of a diphosphinic acid salt and/or polymers thereof, 1-30 wt. % of at least one organic phosphorus-containing flameproofing agent, and possible further additives.

DE-A 102004049342 discloses thermoplastic moulding compositions comprising 10-98 wt. % of thermoplastic polymer, 0.01-50 wt. % of highly branched polycarbonate or highly branched polyester or mixtures thereof, 1-40 wt. % of halogen-free flameproofing agent chosen from the group of P-containing or N-containing compounds or of P—N condensates or mixtures thereof, and possible further additives.

JP-A 2001-335699 describes flameproofed resin compositions comprising two or more thermoplastic resins chosen from styrene resin, aromatic polyester resin, polyamide resin, polycarbonate resin and polyphenylene ether resin and one or more (in)organic phosphinic acid salts, and possible further additives.

JP-A 2001-261973 (Daicel Chemical Industries Ltd.) describes compositions of thermoplastic resins and (in)organic phosphinic acid salts. A combination of PBT, calcium phosphinate and PTFE is given as an example.

JP-A 2002-161211 discloses compositions of thermoplastic resins and flameproofing agents, such as salts of phosphinic and phosphoric acid and derivatives thereof. A combination of PBT, ABS, polyoxyphenylene, calcium phosphinate, an organophosphate and glass fibres is given as an example.

Flameproofing agents which are conventional according to the prior art for polycarbonate/ABS blends are organic aromatic phosphates. These compounds can be in a low molecular weight form, in the form of a mixture of various oligomers or in the form of a mixture of oligomers with low molecular weight compounds (e.g. WO-A 99/16828 and WO-A 00/31173). The good activity as flameproofing agents is counteracted adversely by the highly plasticizing action of these compounds on the polymeric constituents, so that the heat distortion temperature of these moulding compositions is not satisfactory for many uses.

### SUMMARY OF THE INVENTION

An object of the present invention was to provide an impact-modified polycarbonate moulding composition having an optimum combination of good flameproofing, high heat distortion temperature, good mechanical properties and good resistance to chemicals.

It has now been found, surprisingly, that a moulding composition, namely, a composition comprising A) polycarbonate, B) graft polymer containing a silicone rubber or silicone/acrylate rubber and C) a salt of a phosphinic acid have the desired profile of properties.

It has thus been found, surprisingly, that a composition comprising
A) 50 to 99.4 parts by wt., preferably 73 to 98 parts by wt., particularly preferably 80 to 90 parts by wt. (in each case based on the sum of the parts by weight of components A+B+C) of aromatic polycarbonate and/or aromatic polyester carbonate,
B) 0.5 to 20 parts by wt., preferably 1 to 12 parts by wt., particularly preferably 3 to 8 parts by wt. (in each case based on the sum of the parts by weight of components A+B+C) of graft polymer containing a silicone rubber or silicone/acrylate rubber,
C) 0.1 to 30 parts by wt., preferably 1 to 15 parts by wt., particularly preferably 7 to 12 parts by wt. (in each case based on the sum of the parts by weight of components A+B+C) of a salt of a phosphinic acid,
D) 0 to 20 parts by wt. (based on the sum of the parts by weight of components A+B+C=100) of rubber free vinyl (co)polymer and/or polyalkylene terephthalate, preferably the composition is free from rubber free vinyl (co)polymer and/or polyalkylene terephthalate,
E) 0 to 50 parts by wt., preferably 0.5 to 25 parts by wt. (in each case based on the sum of the parts by weight of components A+B+C=100) of additives,
   wherein all the parts by weight stated in the present application are standardized such that the sum of the parts by weight of components A+B+C in the composition is 100, can be capable of achieving the abovementioned technical object.

Other products and methods in accordance with the present invention are provided in the detailed description and claims that follow below. Additional objects, features, and advantages will be sent forth in the description that follows, and in part, will be obvious from the description, or may be learned by practice of the invention. The objects, features, and advantages may be realized and obtained by means of the instrumentalities and combination particularly pointed out in the appended claims.

### DETAILED DESCRIPTION OF THE INVENTION

Component A

Aromatic polycarbonates and/or aromatic polyester carbonates according to component A which are suitable according to the invention are known from the literature or can be prepared by any desired processes known from the literature (for the preparation of aromatic polycarbonates see, for example, Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610 and DE-A 3 832 396; for the preparation of aromatic polyester carbonates e.g. DE-A 3 077 934).

Aromatic polycarbonates can be prepared e.g. by reaction of diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents which are trifunctional or more than trifunctional, for example triphenols or tetraphenols. A preparation via a melt polymerization process by reaction of diphenols with, for example, diphenyl carbonate is likewise possible.

Diphenols for the preparation of the aromatic polycarbonates and/or aromatic polyester carbonates are preferably those of the formula (I)

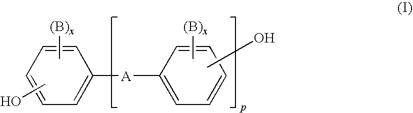

wherein
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, on to which further aromatic rings optionally containing hetero atoms can be fused,
   or a radical of the formula (II) or (III)

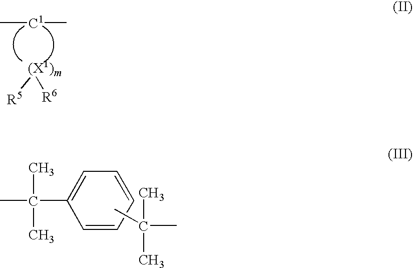

B is in each case C₁ to C₁₂-alkyl, preferably methyl, or halogen, preferably chlorine and/or bromine,
x is in each case independently of one another 0, 1 or 2,
p is 1 or 0, and
R⁵ and R⁶ can be chosen individually for each X¹ and independently of one another denote hydrogen or C₁ to C₆-alkyl, preferably hydrogen, methyl or ethyl,
X¹ denotes carbon and
m denotes an integer from 4 to 7, preferably 4 or 5, with the proviso that on at least one atom X¹R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl)sulfoxides, bis-(hydroxyphenyl)ketones, bis-(hydroxyphenyl)sulfones and α,α-bis-(hydroxyphenyl)-diisopropyl-benzenes and derivatives thereof brominated on the nucleus and/or chlorinated on the nucleus.

Particularly preferred diphenols are 4,4′-dihydroxydiphenyl, bisphenol-A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl sulfone and di- and tetrabrominated or chlorinated derivatives thereof, such as, for example, 2,2-bis(3-chloro-4-hydroxy-phenyl)-propane, 2,2-bis-(3,5-dichloro-4-hydroxyphenyl)-propane or 2,2-bis-(3,5-dibromo-4-hydroxy-phenyl)-propane. 2,2-Bis-(4-hydroxyphenyl)-propane (bisphenol A) is particularly preferred.

The diphenols can be employed individually or as any desired mixtures. The diphenols are known from the literature or obtainable by processes known from the literature.

Chain terminators which are suitable for the preparation of the thermoplastic aromatic polycarbonates are, for example, phenol, p-chlorophenol, p-tert-butylphenol or 2,4,6-tribromophenol, but also long-chain alkylphenols, such as 4-[2-(2,4,4-trimethylpentyl)]-phenol, 4-(1,3-tetramethylbutyl)-phenol according to DE-A 2 842 005 or monoalkylphenols or dialkylphenols having a total of 8 to 20 carbon atoms in the alkyl substituents, such as 3,5-di-tert-butylphenol, p-iso-octylphenol, p-tert-octylphenol, p-dodecylphenol and 2-(3,5-dimethylheptyl)-phenol and 4-(3,5-dimethylheptyl)-phenol. The amount of chain terminators to be employed is in general between 0.5 mol % and 10 mol %, based on the sum of the moles of the particular diphenols employed.

The thermoplastic aromatic polycarbonates preferably have average weight-average molecular weights (M_{w}, measured e.g. by GPC, ultracentrifuge or scattered light measurement) of from 10,000 to 200,000 g/mol, preferably 15,000 to 80,000 g/mol, particularly preferably 24,000 to 32,000 g/mol.

The thermoplastic aromatic polycarbonates can be branched if desired, in a known manner, and particularly preferably by incorporation of from 0.05 to 2.0 mol %, based on the sum of the diphenols employed, of compounds which are trifunctional or more than trifunctional, for example those having three and more phenolic groups.

Both homopolycarbonates and copolycarbonates are suitable. 1 to 25 wt. %, preferably 2.5 to 25 wt. %, based on the total amount of diphenols to be employed, of polydiorganosiloxanes having hydroxyaryloxy end groups can also be employed for the preparation of the copolycarbonates according to the invention according to component A. These are known (U.S. Pat. No. 3,419,634) and can be prepared by processes known from the literature. The preparation of copolycarbonates containing polydiorganosiloxane is described in DE-A 3 334 782.

Preferred polycarbonates are, in addition to bisphenol A homopolycarbonates, copolycarbonates of bisphenol A with up to 15 mol %, based on the sum of the moles of diphenols, of other diphenols mentioned as preferred or particularly preferred, in particular 2,2-bis(3,5-dibromo-4-hydroxyphenyl)-propane.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and of naphthalene-2,6-dicarboxylic acid.

Mixtures of the diacid dichlorides of isophthalic acid and of terephthalic acid in a ratio of between 1:20 and 20:1 are particularly preferred.

A carbonic acid halide, preferably phosgene, can additionally be co-used as a bifunctional acid derivative in the preparation of polyester carbonates.

Possible chain terminators for the preparation of the aromatic polyester carbonates include, in addition to the monophenols already mentioned, also chlorocarbonic acid esters thereof and the acid chlorides of aromatic monocarboxylic acids, which can optionally be substituted by C₁ to C₂₂-alkyl groups or by halogen atoms, and aliphatic C₂ to C₂₂-monocarboxylic acid chlorides.

The amount of chain terminators is in each case 0.1 to 10 mol %, based on the moles of diphenol in the case of the phenolic chain terminators and on the moles of dicarboxylic acid dichloride in the case of monocarboxylic acid chloride chain terminators.

The aromatic polyesters carbonates can also contain incorporated aromatic hydroxycarboxylic acids.

The aromatic polyester carbonates can be either linear or branched in a known manner (in this context see, i.e., DE-A 2 940 024 and DE-A 3 007 934).

Branching agents which can be used are, for example, carboxylic acid chlorides which are trifunctional or more than trifunctional, such as trimesic acid trichloride, cyanuric acid trichloride, 3,3′,4,4′-benzo-phenone-tetracarboxylic acid tetrachloride, 1,4,5,8-naphthalenetetracarboxylic acid tetrachloride or pyromellitic acid tetrachloride, in amounts of from 0.01 to 1.0 mol-% (based on the dicarboxylic acid dichlorides employed), or phenols which are trifunctional or more than trifunctional, such as phloro-glucinol, 4,6-dimethyl-2,4,6-tri-(4-hydroxyphenyl)-hept-2-ene, 4,6-dimethyl-2,4-6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane or 1,4-bis[4,4′-dihydroxytriphenyl)-methyl]-benzene, in amounts of from 0.01 to 1.0 mol %, based on the diphenols employed. Phenolic branching agents can be initially introduced with the diphenols, and acid chloride branching agents can be introduced together with the acid dichlorides.

The content of carbonate structural units in the thermoplastic aromatic polyester carbonates can vary as desired. The content of carbonate groups is preferably up to 100 mol %, in particular up to 80 mol %, particularly preferably up to 50 mol %, based on the sum of ester groups and carbonate groups. Both the ester and the carbonate content of the aromatic polyester carbonates can be present in the polycondensate in the form of blocks or randomly distributed.

The relative solution viscosity (ηᵣₑₗ) of the aromatic polycarbonates and polyester carbonates is advantageously in the range of 1.18 to 1.4, preferably 1.20 to 1.32 (measured on solutions of 0.5 g of polycarbonate or polyester carbonate in 100 ml of methylene chloride solution at 25° C.).

The thermoplastic aromatic polycarbonates and polyester carbonates can be employed by themselves or in any desired mixture.

Component B

Component B includes one or more graft polymers of
B.1 5 to 95, preferably 10 to 90 wt. % of one or more vinyl monomers and
B.2 95 to 5, preferably 90 to 10 wt. % of one or more graft bases chosen from the group of silicone rubbers (B.2.1) and silicone/acrylate rubbers (B.2.2).

The graft polymers B can be, prepared for example, by free-radical polymerization, e.g. by emulsion, suspension, solution or bulk polymerization, preferably by emulsion or bulk polymerization.

Suitable monomers B.1 include vinyl monomers, such as vinylaromatics and/or vinylaromatics substituted on the nucleus (such as styrene, α-methylstyrene, p-methylstyrene and p-chlorostyrene), methacrylic acid (C₁-C₈)-alkyl esters (such as methyl methacrylate, ethyl methacrylate, 2-ethylhexyl methacrylate and allyl methacrylate), acrylic acid (C₁-C₈)-alkyl esters (such as methyl acrylate, ethyl acrylate, n-butyl acrylate and t-butyl acrylate), organic acids (such as acrylic acid and methacrylic acid) and/or vinyl cyanides (such as acrylonitrile and methacrylonitrile), and/or derivatives (such as anhydrides and imides) of unsaturated carboxylic acids (for example maleic anhydride and N-phenyl-maleimide). These vinyl monomers can be used by themselves or in mixtures of at least two monomers.

Preferred monomers B.1 are chosen from at least one of the monomers styrene, α-methylstyrene, methyl methacrylate, n-butyl acrylate and acrylonitrile. Methyl methacrylate is particularly preferably employed as the monomer B.1.

The glass transition temperature of the graft base B.2 advantageously is <10° C., preferably <0° C., particularly preferably <−20° C. The graft base B.2 in general preferably has an average particle size (d₅₀ value) of from 0.05 to 10 μm, more preferably 0.06 to 5 μm, particularly preferably 0.08 to 1 μm.

The average particle size d₅₀ is the diameter above and below which in each case 50 wt. % of the particles lie. It can be determined by means of ultracentrifuge measurement (W. Scholtan, H. Lange, Kolloid-Z. und Z. Polymere 250 (1972), 782-796).

Suitable silicone rubbers according to B.2.1 include silicone rubbers having grafting-active sites, the preparation method of which is described, for example, in U.S. Pat. No. 2,891,920, U.S. Pat. No. 3,294,725, DE-OS 3 631 540, EP 249964, EP 430134 and U.S. Pat. No. 4,888,388.

The silicone rubber according to B.2.1 is preferably prepared by emulsion polymerization, in which siloxane monomer units, crosslinking or branching agents (IV) and optionally grafting agents (V) are employed.

Siloxane monomer units which are employed are, for example and preferably, dimethylsiloxane or cyclic organosiloxanes having at least 3 ring members, preferably 3 to 6 ring members, such as, for example and preferably, hexamethylcyclotrisiloxane, octamethylcyclotetrasiloxane, decamethylcyclopentasiloxane, dodecamethylcyclohexasiloxane, trimethyl-triphenyl-cyclotrisiloxanes, tetramethyl-tetraphenyl-cyclotetrasiloxanes and octaphenylcyclotetrasiloxane.

The organosiloxane monomers can be employed by themselves or in the form of mixtures with 2 or more monomers. The silicone rubber preferably contains not less than 50 wt. % and particularly preferably not less than 60 wt. % of organosiloxane, based on the total weight of the silicone rubber component.

Silane-based crosslinking agents having a functionality of 3 or 4, particularly preferably 4, are preferably used as crosslinking or branching agents (IV). There may be mentioned by way of example and preferably: trimethoxymethylsilane, triethoxyphenylsilane, tetramethoxysilane, tetraethoxysilane, tetra-n-propoxysilane and tetrabutoxysilane. The crosslinking agent can be employed by itself or in a mixture of two or more. Tetraethoxysilane is particularly preferred.

The crosslinking agent is preferably employed in a range of amounts of between 0.1 and 40 wt. %, based on the total weight of the silicone rubber component. The amount of crosslinking agent can advantageously chosen such that the degree of swelling of the silicone rubber, measured in toluene, is between 3 and 30, preferably between 3 and 25 and particularly preferably between 3 and 15. The degree of swelling is defined as the weight ratio between the amount of toluene which is absorbed by the silicone rubber when it is saturated with toluene at 25° C. and the amount of silicone rubber in the dried state. The degree of swelling is described in detail in EP 249964.

If the degree of swelling is less than about 3, i.e. if the content of crosslinking agent is too high, the silicone rubber may not show an adequate rubber elasticity. If the swelling index is greater than about 30, the silicone rubber may not be able to form a domain structure in the matrix polymer and therefore also may not as readily improve the impact strength, and thus, the effect would then be similar to a simple addition of polydimethylsiloxane.

Tetrafunctional crosslinking agents are preferred in some cases over trifunctional, because the degree of swelling can then be controlled more easily within the limits described above.

Suitable grafting agents (V) include compounds which are capable of forming structures of the following formulae:

CH₂═C(R²)—COO—(CH₂)ₚ—SiR¹ₙO_{(3-n)/2} (V-1)

CH₂═CH—SiR¹ₙO_{(3-n)/2} (V-2) or

HS—(CH₂)ₚ—SiR¹ₙO_{(3-n)/2} (V-3),

wherein
R¹ represents C₁-C₄-alkyl, preferably methyl, ethyl or propyl, or phenyl,
R² represents hydrogen or methyl,
n denotes 0, 1 or 2 and
p denotes an integer from 1 to 6.

Acryloyl- or methacryloyloxysilanes are particularly suitable for forming the abovementioned structure (V-1) and have a high grafting efficiency. An effective formation of the graft chains can thereby often be optimized, and the impact strength of the resulting resin composition is therefore favoured.

There may be mentioned by way of example and preferably: β-methacryloyloxy-ethyldimethoxymethyl-silane, γ-methacryloyloxy-propylmethoxydimethyl-silane, γ-methacryloyloxy-propyldimethoxymethyl-silane, γ-methacryloyloxy-propyltrimethoxy-silane, γ-methacryloyloxy-propylethoxydiethyl-silane, γ-methacryloyloxy-propyldiethoxymethyl-silane, δ-methacryloyloxy-butyldiethoxymethyl-silanes or mixtures of these.

0 to 20 wt. % of grafting agent, based on the total weight of the silicone rubber, is preferably employed.

The silicone rubber can be prepared by emulsion polymerization, as described, for example, in U.S. Pat. No. 2,891,920 and U.S. Pat. No. 3,294,725. The silicone rubber is obtained by this means in the form of an aqueous latex. For this, a mixture containing organosiloxane, crosslinking agent and optionally grafting agent is mixed with water under the action of shearing forces, for example by a homogenizer, in the presence of an emulsifier based on sulfonic acid, such as e.g. alkylbenzenesulfonic acid or alkylsulfonic acid, the mixture polymerizing to give the silicone rubber latex. An alkylbenzenesulfonic acid is particularly suitable, since it is capable of acting not only as an emulsifier but also as a polymerization initiator. In this case, a combination of the sulfonic acid with a metal salt of an alkylbenzenesulfonic acid or with a metal salt of an alkylsulfonic acid is favourable, because the polymer is thereby stabilized during the later grafting polymerization.

After the polymerization, the reaction is ended by neutralizing the reaction mixture by addition of an aqueous alkaline solution, e.g. by addition of an aqueous sodium hydroxide, potassium hydroxide or sodium carbonate solution.

According to the invention, silicone/acrylate rubbers (B.2.2) are also suitable as graft bases B.2. These silicone/acrylate rubbers are preferably composite rubbers having grafting-active sites containing a silicone rubber content of 10-90 wt. % and a polyalkyl (meth)acrylate rubber content of 90 to 10 wt. %, the two rubber components mentioned penetrating each other in the composite rubber, so that they cannot be separated substantially from one another.

If the content of the silicone rubber component in the composite rubber is too high, the finished resin compositions may have adverse surface properties and cannot be coloured so readily. On the other hand, if the content of the polyalkyl(meth)acrylate rubber component in the composite rubber is too high, the impact strength of the finished resin composition may be adversely influenced.

Silicone/acrylate rubbers are known and are described, for example, in U.S. Pat. No. 5,807,914, EP 430134 and U.S. Pat. No. 4,888,388.

Suitable silicone rubber components of the silicone/acrylate rubbers according to B.2.2 include those, for example, such as are already described under B.2.1.

Suitable polyalkyl(meth)acrylate rubber components of the silicone/acrylate rubbers according to B.2.2 can be prepared, for example, from methacrylic acid alkyl esters and/or acrylic acid alkyl esters, a crosslinking agent (VI) and a grafting agent (VII). Preferred methacrylic acid alkyl esters and/or acrylic acid alkyl esters by way of example here are the C₁ to C₈-alkyl esters, for example methyl, ethyl, n-butyl, t-butyl, n-propyl, n-hexyl n-octyl, n-lauryl and 2-ethylhexyl esters; haloalkyl esters, preferably halo-C₁-C₈-alkyl esters, such as chloroethyl acrylate, and mixtures of these monomers. n-Butyl acrylate is particularly preferred.

Crosslinking agents (VI) which can be employed for the polyalkyl(meth)acrylate rubber component of the silicone/acrylate rubber include monomers having more than one polymerizable double bond. Preferred examples of crosslinking monomers are esters of unsaturated monocarboxylic acids having 3 to 8 C atoms and unsaturated monohydric alcohols having 3 to 12 C atoms, or of saturated polyols having 2 to 4 OH groups and 2 to 20 C atoms, such as ethylene glycol dimethacrylate propylene glycol dimethacrylate, 1,3-butylene glycol dimethacrylate and 1,4-butylene glycol dimethacrylate. The crosslinking agents can be used by themselves or in mixtures of at least two crosslinking agents.

Preferred grafting agents (VII) by way of example are allyl methacrylate, triallyl cyanurate, triallyl isocyanurate or mixtures thereof. Allyl methacrylate can also be employed as the crosslinking agent (VI). The grafting agents can be used by themselves or in mixtures of at least two grafting agents.

The amount of crosslinking agent (VI) and grafting agent (VII) is preferably 0.1 to 20 wt. %, based on the total weight of the polyalkyl(meth)acrylate rubber component of the silicone/acrylate rubber.

The silicone/acrylate rubber can be prepared by first preparing the silicone rubber according to B.2.1 as an aqueous latex. This latex is then enriched with the methacrylic acid alkyl esters and/or acrylic acid alkyl esters to be used, the crosslinking agent (VI) and the grafting agent (VII), and a polymerization is carried out. An emulsion polymerization initiated by free radicals, for example by a peroxide initiator or an azo or redox initiator, is preferred. The use of a redox initiator system, specifically of a sulfoxylate initiator system prepared by combination of iron sulfate, disodium ethylenediaminetetraacetate, Rongalit and hydroperoxide, is particularly preferred.

The grafting agent (V) used in the preparation of the silicone rubber leads in this context to the polyalkyl(meth)acrylate rubber content being bonded covalently to the silicone rubber content. During the polymerization, the two rubber components penetrate each other and in this way form the composite rubber, which can no longer be separated into its constituents of silicone rubber component and polyalkyl(meth)acrylate rubber component after the polymerization.

For preparation of the silicone(/acrylate) graft rubbers B mentioned as component B), the monomers B.1 are advantageously grafted on to the rubber base B.2.

In this context, the polymerization methods described, for example, in EP 249964, EP 430134 and U.S. Pat. No. 4,888,388 can be used.

For example, the grafting polymerization can suitably be carried out by the following polymerization method: The desired vinyl monomers B.1 are polymerized on to the graft base, which is in the form of an aqueous latex, in a one- or multistage emulsion polymerization initiated by free radicals. The grafting efficiency in this context should preferably be as high as possible and is preferably greater than or equal to 10%. The grafting efficiency depends decisively on the grafting agents (V) and (VII) used. After the polymerization to give the silicone(/acrylate) graft rubber, the aqueous latex is introduced into hot water, in which metal salts, such as e.g. calcium chloride or magnesium sulfate, have been dissolved beforehand. The silicone(/acrylate) graft rubber coagulates during this procedure and can than be separated.

The methacrylic acid alkyl ester and acrylic acid alkyl ester graft rubbers mentioned as component B) are commercially obtainable. There may be mentioned by way of example: Metablen® SX 005 and Metablen® SRK 200 from Mitsubishi Rayon Co. Ltd.

Component C

The salt of a phosphinic acid (component C) in the context according to the invention is to be understood as meaning the salt of a phosphinic acid with any desired metal cation. Mixtures of salts which differ in their metal cation can also be employed. The metal cations are the cations of metals of main group 1 (alkali metals, preferably Li⁺, Na⁺, K⁺), of main group 2 (alkaline earth metals; preferably Mg²⁺, Ca²⁺, Sr²⁺, Ba²⁺, particularly preferably Ca²⁺) or of main group 3 (elements of the boron group; preferably Al³⁺) and/or of subgroup 2, 7 or 8 (preferably Zn²⁺, Mn²⁺, Fe²⁺, Fe³⁺) of the periodic table.

A salt or a mixture of salts of a phosphinic acid of the formula (IV) is preferably employed

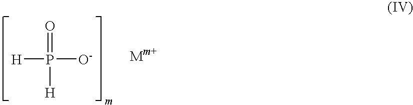

wherein M^{m+} is a metal cation of main group 1 (alkali metals; m=1), main group 2 (alkaline earth metals; m=2) or of main group 3 (m=3) or of subgroup 2, 7 or 8 (wherein m denotes an integer from 1 to 6, preferably 1 to 3 and particularly preferably 2 or 3) of the periodic table.

Particularly preferably, in formula (IV)

for m=1 the metal cations M⁺=Li⁺, Na⁺, K⁺,

for m=2 the metal cations M²⁺=Mg²⁺, Ca²⁺, Sr²⁺, Ba²⁺ and

for m=3 the metal cations M³⁺=Al³⁺,

Ca²⁺(m=2) and Al³⁺(m=3) are very preferred.

In a preferred embodiment, the average particle size d₅₀ of the phosphinic acid salt (component C) is not more than 80 μm, preferably not more than 60 μm, and d₅₀ is particularly preferably from 10 μm to 55 μm. The average particle size d₅₀ is the diameter above and below which in each case 50 wt. % of the particles lie. Mixtures of salts which differ in their average particle size d₅₀ can also be employed.

These particle size d₅₀ requirements of the phosphinic acid salt are in each case associated with the technical effect that the flameproofing efficiency of the phosphinic acid salt is increased.

The phosphinic acid salt can be employed either by itself and/or in combination with other phosphorus-containing flameproofing agents. The compositions according to the invention are preferably free from phosphorus-containing flameproofing agents chosen from the group of mono- and oligomeric phosphoric and phosphonic acid esters, phosphonate-amines and phosphazenes. These other phosphorus-containing flameproofing agents such as mono- and oligomeric phosphoric and phosphonic acid esters have a negative effect (when compared with phosphinic acid salts) with regard to the heat distortion temperature of the molding compositions.

Component D

Optional component D includes one or more thermoplastic vinyl (co)polymers D.1 and/or polyalkylene terephthalates D.2.

Suitable vinyl (co)polymers D.1 preferably include polymers of at least one monomer from the group of vinylaromatics, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. (Co)polymers which are suitable in particular are those of
D.1.1 50 to 99, preferably 60 to 80 parts by wt. of vinylaromatics and/or vinylaromatics substituted on the nucleus, such as styrene, α-methylstyrene, p-methylstyrene and p-chlorostyrene, and/or (meth)acrylic acid (C₁-C₈)-alkyl esters, such as methyl methacrylate and ethyl methacrylate, and
D.1.2 1 to 50, preferably 20 to 40 parts by wt. of vinyl cyanides (unsaturated nitriles), such as acrylonitrile and methacrylonitrile, and/or (meth)acrylic acid (C₁-C₈)-alkyl esters, such as methyl methacrylate, n-butyl acrylate and t-butyl acrylate, and/or unsaturated carboxylic acids, such as maleic acid, and/or derivatives, such as anhydrides and imides, of unsaturated carboxylic acids, for example maleic anhydride and N-phenylmaleimide.

The vinyl (co)polymers D.1 are resinous, thermoplastic and rubber-free. The copolymer of D.1.1 styrene and D.1.2 acrylonitrile is particularly preferred.

The (co)polymers according to D.1 are known and can be prepared by free-radical polymerization, in particular by emulsion, suspension, solution or bulk polymerization. The (co)polymers preferably have average molecular weights Mw (weight-average, determined by light scattering or sedimentation) of between 15,000 and 200,000.

The polyalkylene terephthalates of component D.2 are advantageously reaction products of aromatic dicarboxylic acids or their reactive derivatives, such as dimethyl esters or anhydrides, and aliphatic, cycloaliphatic or araliphatic diols, and mixtures of these reaction products.

Preferred polyalkylene terephthalates preferably contain at least 80 wt. %, more preferably at least 90 wt. %, based on the dicarboxylic acid component, of terephthalic acid radicals and preferably at least 80 wt. %, more preferably at least 90 wt. %, based on the diol component, of radicals of ethylene glycol and/or butane-1,4-diol.

The preferred polyalkylene terephthalates can contain, in addition to terephthalic acid radicals, up to 20 mol %, preferably up to 10 mol % of radicals of other aromatic or cycloaliphatic dicarboxylic acids having 8 to 14 C atoms or aliphatic dicarboxylic acids having 4 to 12 C atoms, such as e.g. radicals of phthalic acid, isophthalic acid, naphthalene-2,6-dicarboxylic acid, 4,4′-diphenyldicarboxylic acid, succinic acid, adipic acid, sebacic acid, azelaic acid and cyclohexanediacetic acid.

The preferred polyalkylene terephthalates can contain, in addition to radicals of ethylene glycol or butane-1,4-diol, up to 20 mol %, preferably up to 10 mol % of other aliphatic diols having 3 to 12 C atoms or cycloaliphatic diols having 6 to 21 C atoms, e.g. radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,6-diol, 2,2-diethylpropane-1,3-diol, hexane-2,5-diol, 1,4-di-(α-hydroxyethoxy)-benzene, 2,2-bis-(4-hydroxycyclohexyl)-propane, 2,4-dihydroxy-1,1,3,3-tetramethyl-cyclobutane, 2,2-bis-(4-\hat{α}-hydroxyethoxy-phenyl)-propane and 2,2-bis-(4-hydroxypropoxyphenyl)-propane (DE-A 2 407 674, 2 407 776 and 2 715 932).

The polyalkylene terephthalates can be branched by incorporation of relatively small amounts of 3- or 4-hydric alcohols or 3- or 4-basic carboxylic acids, e.g. in accordance with DE-A 1 900 270 and U.S. Pat. No. 3,692,744. Examples of preferred branching agents are trimesic acid, trimellitic acid, trimethylolethane and -propane and pentaerythritol.

Polyalkylene terephthalates which have been prepared solely from terephthalic acid and reactive derivatives thereof (e.g. dialkyl esters thereof) and ethylene glycol and/or butane-1,4-diol and mixtures of these polyalkylene terephthalates are particularly preferred.

Mixtures of polyalkylene terephthalates contain 1 to 50 wt. %, preferably 1 to 30 wt. % of polyethylene terephthalate and 50 to 99 wt. %, preferably 70 to 99 wt. % of polybutylene terephthalate.

The polyalkylene terephthalates preferably used in general have a limiting viscosity of from 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates can be prepared by known methods (see e.g. Kunststoff-Handbuch, volume VIII, p. 695 et seq., Carl-Hanser-Verlag, Munich 1973).

Component E

The composition can optionally comprise further commercially available additives according to component E), such as rubber-modified graft polymers E* which differ from component B), flameproofing synergists, antidripping agents (for example compounds of the substance classes of fluorinated polyolefins, of silicones and aramid fibres), lubricants and mould release agents (for example pentaerythritol tetrastearate), nucleating agents, stabilizers, antistatics (for example conductive carbon blacks, carbon fibres, carbon nanotubes and organic antistatics, such as polyalkylene ethers, alkylsulfonates or polyamide-containing polymers), acids, fillers and reinforcing substances (for example glass fibres or carbon fibres, mica, kaolin, talc, CaCO₃ and glass flakes) and dyestuffs and pigments.

The graft polymers E* which differ from component B include, in particular, one or more graft polymers of
E.1 5 to 95 wt. % of at least one vinyl monomer and
E.2 95 to 5 wt. % of at least one graft base chosen from the group consisting of diene rubbers, EP(D)M rubbers (i.e. those based on ethylene/propylene and optionally diene) and acrylate, polyurethane, chloroprene and ethylene/vinyl acetate rubbers.

Monomers E.1 are preferably a mixture of
E.1.1 50 to 99 parts by wt. (on the sum of the parts by weight of components E.1.1+E.1.2=100 parts by wt.) of vinylaromatics and/or vinylaromatics substituted on the nucleus (such as styrene, α-methylstyrene, p-methylstyrene and p-chlorostyrene) and/or (meth)acrylic acid (C₁-C₈)-alkyl esters (such as methyl methacrylate and ethyl methacrylate) and
E.1.2 1 to 50 parts by wt. (on the sum of the parts by weight of components E.1.1+E.1.2=100 parts by wt.) of vinyl cyanides (unsaturated nitriles, such as acrylonitrile and methacrylonitrile) and/or (meth)acrylic acid C₁-C₈-alkyl esters, such as methyl methacrylate, n-butyl acrylate and t-butyl acrylate, and/or derivatives (such as anhydrides and imides) of unsaturated carboxylic acids, for example maleic anhydride and N-phenyl-maleimide.

The compositions according to the invention are preferably free from graft polymers E* which differ from component B.

Preparation of the Moulding Compositions and Shaped Articles

The thermoplastic moulding compositions according to the invention can be prepared, for example, by mixing the particular constituents in a known manner and subjecting the mixture to melt compounding and melt extrusion at temperatures of from 240° C. to 300° C. in conventional units, such as internal kneaders, extruders and twin-screw extruders.

The mixing of the individual constituents can be carried out in a known manner either successively or simultaneously, and in particular either at about 20° C. (room temperature) or at a higher temperature.

The invention likewise provides processes for the preparation of the moulding compositions and the use of the moulding compositions for the production of shaped articles and the mouldings themselves.

The moulding compositions according to the invention can be used for the production of all types of shaped articles. These can be produced, for example, by injection moulding, extrusion and blow moulding processes. A further form of processing is the production of shaped articles by thermoforming from previously produced sheets or films.

Examples of such shaped articles include films, profiles, housing components of all types, e.g. for domestic appliances, such as televisions, juice presses, coffee machines and mixers; for office machines, such as monitors, flatscreens, notebooks, printers and copiers; sheets, tubes, electrical installation conduits, windows, doors and further profiles for the building sector (interior finishing and exterior uses) and electrical and electronic components, such as switches, plugs and sockets, and vehicle body or interior components for utility vehicles, in particular for the automobile sector.

The moulding compositions according to the invention can also be used in particular, for example, for the production of the following shaped articles or mouldings: interior finishing components for rail vehicles, ships, aircraft, buses and other motor vehicles, housing of electrical equipment containing small transformers, housing for equipment for processing and transmission of information, housing and lining of medical equipment, massage equipment and housing therefor, toy vehicles for children, planar wall elements, housing for safety equipment and for televisions, thermally insulated transportation containers, mouldings for sanitary and bath fittings, cover grids for ventilator openings and housing for garden equipment.

The following examples serve to explain the invention further.

### EXAMPLES

Component A

Branched polycarbonate based on bisphenol A having a relative solution viscosity of ηᵣₑₗ=1.34, measured in CH₂Cl₂ as the solvent at 25° C. and a concentration of 0.5 g/100 ml, which has been branched by employing 0.3 mol % of isatin-biscresol, based on the sum of bisphenol A and isatin-biscresol.

Component B-1

Impact modifier, methyl methacrylate-modified silicone/acrylate rubber, Metablen® SX 005 from Mitsubishi Rayon Co., Ltd., CAS 143106-82-5.

Component B-2

Impact modifier, styrene/acrylonitrile-modified silicone/acrylate rubber, Metablen® SRK 200 from Mitsubishi Rayon Co., Ltd., CAS 178462-89-0.

Component C

Component C-1 (Comparison)

Oligophosphate based on bisphenol A

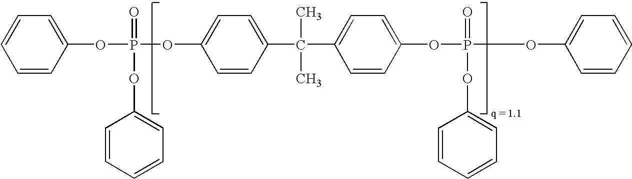

Component C-2

Calcium phosphinate, average particle size d₅₀=50 μm.

Component E

Component E-1: polytetrafluoroethylene (PTFE)

Component E-2: pentaerythritol tetrastearate

Component E-3: Irganox B900 (manufacturer: Ciba Specialty Chemicals Inc., Basle, Switzerland)

Preparation and Testing of the Moulding Compositions

The starting substances listed in Table 1 are compounded and granulated on a twin-screw extruder (ZSK-25) (Werner und Pfleiderer) at a speed of rotation of 225 rpm and a throughput of 20 kg/h at a machine temperature of 260° C.

The finished granules are processed on an injection moulding machine to give the corresponding test specimens (melt temperature 260° C., mould temperature 80° C., melt front speed 240 mm/s). Characterization is carried out in accordance with DIN EN ISO 180/1A (Izod notched impact strength a_{K}), DIN EN ISO 527 (tensile E modulus), DIN ISO 306 (Vicat softening temperature, method B with a load of 50 N and a heating rate of 120 K/h), ISO 4599 (environmental stress cracking (ESC) test against toluene:isopropanol 60:40, exposure of the test specimen for 10 min at 2.4% edge fibre elongation at room temperature) and UL 94 V (measured on bars of dimensions 127×12.7×1.5 mm).

It can be seen from Table 1 that only the compositions of Examples 2 and 3 with the combination of polycarbonate, silicone impact modifier and calcium phosphinate achieve the object according to the invention, i.e. offer a combination of good flameproofing, high heat distortion temperature, good mechanical properties and good resistance to chemicals.

While the foregoing description teaches the principles of the present invention, with examples provided for the purpose of illustration, it will be understood that the practice of the invention encompasses all variations, adaptations, or modifications considered by those skilled in the art and encompassed by the following claims. As used herein and in the following claims, articles such as “a”, “an”, “the” can connote singular or plural.

TABLE 1
Compositions and their properties

| | | 1 | | |
|---|---|---|---|---|
| | | (comp.) | 2 | 3 |
| Composition | | | | |
| A | pt. by wt. | 85.2 | 85.2 | 85.2 |
| B-1 | pt. by wt. | 4.7 | 4.7 | |
| B-2 | pt. by wt. | | | 4.7 |
| C-1 | pt. by wt. | 10.1 | | |
| C-2 | pt. by wt. | | 10.1 | 10.1 |
| E-1 | pt. by wt. | 0.4 | 0.4 | 0.4 |
| E-2 | pt. by wt. | 0.2 | 0.2 | 0.2 |
| E-3 | pt. by wt. | 0.1 | 0.1 | 0.1 |
| Properties | | | | |
| a_{K}/RT (DIN EN ISO 180/1A) | kJ/m² | | 70.2 | 69.1 |
| [tough] | | | | |
| a_{K}/RT | kJ/m² | 11.2 | | |
| (DIN EN ISO 180/1A) [brittle] | | | | |
| aₖ/−30° C. | kJ/m² | 7.9 | 26.2 | 19.2 |
| (DIN EN ISO 180/1A) [brittle] | | | | |
| Tensile E modulus | N/mm² | 2515 | 2673 | 2753 |
| (DIN EN ISO 527) | | | | |
| Vicat B 120 (DIN ISO 306) | ° C. | 114 | 145 | 145 |
| ESC properties/[2.4%] | rating | BR | n. BR | n. BR |
| Burning properties | | | | |
| (UL 94 V, 1.5 mm) | | | | |
| UL 94 V 1.5 mm/2 d [rating] | | V0 | V0 | V0 |
| UL 94 V 1.5 mm/2 d | s | 13 | 7 | 7 |
| [total ABT] | | | | |

BR = break
n. BR = no break
ABT = after burning time

1. A compositions comprising
A) 50 to 99.4 parts by wt., in each case based on the sum of the parts by weight of components A+B+C, of an aromatic polycarbonate and/or aromatic polyester carbonate,
B) 0.5 to 20 parts by wt., in each case based on the sum of the parts by weight of components A+B+C, of a graft polymer comprising a silicone rubber or silicone/acrylate rubber,
C) 0.1 to 30 parts by wt., in each case based on the sum of the parts by weight of components A+B+C, of a salt of a phosphinic acid.

2. A composition according to claim 1, comprising 3 to 8 parts by wt., in each case based on the sum of the parts by weight of components A+B+C, of a graft polymer comprising a silicone rubber or silicone/acrylate rubber according to component B.

3. A composition according to claim 1, comprising 7 to 12 parts by wt., in each case based on the sum of the parts by weight of components A+B+C, of a salt of a phosphinic acid.

5. A composition according to claim 1, comprising 0 to 20 parts by wt., based on the sum of the parts by weight of components A+B+C=100, of a rubber free vinyl (co)polymer and/or polyalkylene terephthalate as component D.

6. A composition according to claim 1 which is free from rubber free vinyl (co)polymers and/or polyalkylene terephthalates.

7. A composition according to claim 1, comprising as component B, at least one graft polymer of
B.1 5 to 95 wt. % of one or more vinyl monomers and
B.2 95 to 5 wt. % of at least one graft base selected from the group consisting of silicon rubbers (B.2.1) and silicone/acrylate rubbers (B.2.2).

8. A composition according to claim 7, comprising as B.1 at least one vinyl monomer selected from the group consisting of styrene, α-methylstyrene, p-methylstyrene, p-chlorostyrene, methyl methacrylate, ethyl methacrylate, 2-ethylhexyl methacrylate, allyl methacrylate, methyl acrylate, ethyl acrylate, n-butyl acrylate, t-butyl acrylate, acrylic acid, methacrylic acid, acrylonitrile, methacrylonitrile, maleic anhydride and N-phenyl-maleimide.

9. A composition according to claim 1, comprising a graft polymer according to component B having a graft base B.2 which has an average particle size (d₅₀ value) of from 0.08 to 1 μm.

10. A composition according to claim 7, wherein the graft polymer comprises a silicone/acrylate rubber (B.2.2) as the graft base B.2.

11. A composition according to claim 10, wherein the silicone/acrylate rubber is a composite rubber having grafting-active sites comprising a first rubber component comprising a silicone rubber with a content of 10-90 wt. % and a second rubber component comprising polyalkyl (meth)acrylate rubber with a content of 90 to 10 wt. %, the two rubber components penetrating each other in the composite rubber, such that said first and second rubber components cannot be separated substantially from one another.

12. A composition according to claim 1, comprising as component C, a salt or a mixture of salts of a phosphinic acid, wherein the metal cation of said salt or of at least one of said mixture of salts is Li⁺, Na⁺, K⁺, Mg²⁺, Ca²⁺, Sr²⁺, Ba²⁺, Al³⁺, Zn²⁺, Mn²⁺, Fe²⁺ and/or Fe³⁺.

13. A composition according to claim 12, comprising as the salt or as at least one of said mixture of salts, a phosphinic acid of the formula (IV) 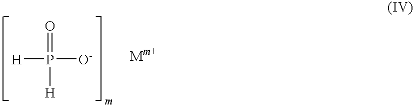
wherein
M^{m+} is a metal cation of main group 1 (alkali metals; m=1), main group 2 (alkaline earth metals; m=2) or of main group 3 (m=3) or of subgroup 2, 7 or 8 (wherein m denotes an integer from 1 to 6) of the periodic table.

14. A composition according to claim 13, wherein M^{m+}=Ca²⁺ and m=2 or M^{m+}=Al³⁺ and m=3.

15. A composition according to claim 1, wherein the average particle size d₅₀ of the phosphinic acid salt component Cis not more than 80 μm.

16. A composition according to claim 1, wherein the composition is free from phosphorus-containing flameproofing agents selected from the group consisting of mono- and oligomeric phosphoric and phosphonic acid esters, phosphonate-amines and phosphazenes.

17. A composition according to claim 1, comprising up to 50 parts by wt., in each case based on the sum of the parts by weight of components A+B+C=100, of at least one additive as component E.

18. A composition according to claim 17, wherein the additive of component E is a rubber-modified graft polymer which differs from component B, a flameproofing synergist, an antidripping agent, a lubricant, a mould release agent, a nucleating agent, a stabilizer, an antistatic, an acid, a filler, a reinforcing substance, a dyestuff and/or a pigment.

19. A composition according to claim 17, wherein the composition is free from graft polymers which differ from component B.

20. A method for the production of a shaped article comprising injection moulding, extrusion moulding, blow moulding processes and/or thermoforming said composition to form said shaped article.

21. A shaped article comprising a composition according to claim 1.

22. A shaped article according to claim 21, wherein the shaped article is a part of a motor vehicle, a part of a rail vehicle, a part of an aircraft, a part of an aquatic vehicle, a film, a profile and/or a housing component.
